(19) United States
(12) Patent Application Publication
(10) Pub. No.: US 2007/0189820 A1
(43) Pub. Date: Aug. 16, 2007

(54) ALIGNING DEVICE FOR OBJECT PLACED ON OFFICE MACHINE

(76) Inventor: HSING-KUAN CHIANG, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/625,519

(22) Filed: Jan. 22, 2007

(30) Foreign Application Priority Data
Feb. 15, 2006 (TW) 095104985

(51) Int. Cl. G03G 15/00

(52) U.S. Cl. 399/377

(57) ABSTRACT

The invention provides an office machine which includes a housing, a transparent platform, and an aligning device. The aligning device includes a casing, a dam member, and at least one resilient member. The dam member has a main body and an extension portion. A gap exists between the extension portion and the platform. If the thickness of an object is less than the gap, the object, placed on the platform, is inserted into the gap to make an edge of the object align with an aligning edge of the casing.

### BACKGROUND OF THE INVENTION

1. Field of the Invention

The present invention relates to an office machine which can assist an edge or two of an object in aligning with the starting edge of the platform of the office machine.

2. Description of the Prior Art

When a user lifts the opening lid of an office machine, like common scanners, photocopying machines, and multi-purpose office machines, to retrieve a document after processes such as placing a single sheet document into a machine, completing scanning, completing photocopying, and so on, inconvenience and trouble frequently occur when the sheet of the document adheres to the lid of the machine, causing the paper to drift randomly in the air when opening the lid.

Referring to FIG. 1A, FIG. 1B, and FIG. 1C, a scanner 10 from prior art is shown in the figures. FIG. 1A is an outside perspective view of the scanner 10. FIG. 1B is a side view of the scanner 10 in FIG. 1A. FIG. 1C is another side view of the scanner 10 in FIG. 1A, for illustrating the raised state of the opening lid 12 of the scanner 10.

Referring to FIG. 1A, FIG. 1B, and FIG. 1C, most opening lids 12 of the scanners 10 in prior art have a cotton 16 and a white chip 17. The cotton 16 is mainly for ensuring that a document 18 to be scanned lays flat on the glass 14 of the scanning platform 15. The white chip 17 acts as the background color of the document 18 when being scanned. Surfaces of most common white chips 17 are smooth, and each surface attaches tightly to the glass 14 of the scanning platform 15 for achieving the best scanning effect.

The air between the document 18 and the white chip 17 of the opening lid 12 is released when closing the opening lid 12, resulting in a nearly vacuum state between the scanning platform 15 and the opening lid 12, subsequently leading to the phenomenon of vacuum-forming, and causing the document 18 to adhere to the opening lid 12. When raising the opening lid 12 after completing the scanning process, the phenomenon of vacuum-forming no longer exists due to air movement, causing random drifting of the document 18 previously attached to the white chip 17 of the opening lid 12.

Furthermore, before proceeding with the action of scanning or photocopying, the document 18 is usually placed on the scanner 10 or the glass 14 of the scanning platform 15 of the photocopying machine, following by the closing of the opening lid 12 for scanning or photocopying. Closing of the opening lid 12 is always affected by air movement, causing the document 18 to deviate from the predetermined starting edge for scanning or photocopying, thus leading to distorted figures from scanning or photocopying and not being able to reach the expected scanning or photocopying effects.

A scope of the present invention is to provide an office machine to resolve the aforementioned problems.

### SUMMARY OF THE INVENTION

A scope of the invention is to provide an office machine with at least one aligning device for assisting in aligning the edge of an object with the starting edge of the office machine.

According to a preferred embodiment of the office machine, the office machine includes a housing, a transparent platform, and a first aligning device. The transparent platform, mounted on the housing, is used for placing thereon an object to be processed (not shown in figures). The transparent platform thereon has a first starting edge, and the object has a thickness. The first aligning device further includes a first starting edge, a first dam member, and a first resilient member. The first casing has a first aligning edge and a first opening formed at the first aligning edge. The first casing is attached on the housing such that the first aligning edge of the first casing is aligned with the first starting edge. The first dam member has a first main body and a first extension portion. The first main body is movably retained inside the first casing. The first extension portion protrudes from the first main body through the first opening, and a first gap exists between the first extension portion and the platform if the first casing is attached on the housing. The first resilient member is disposed between an inner wall of the first casing and the first dam member, so as to press against the first main body of the first dam member. If the thickness of the object is less than the first gap, the object, placed on the platform, is inserted into the first gap to make a first edge of the object align with the first aligning edge of the first casing. If the thickness of the object is greater than the first gap, the object, placed on the platform, is pushed via the first edge thereof against the first extension portion, such that the first resilient member is compressed, forcing the first dam member to move inward to the first casing, and the first edge of the object is aligned with the first aligning edge of the first casing.

The advantage and spirit of the invention may be understood by the following recitations together with the appended drawings.

### BRIEF DESCRIPTION OF THE APPENDED DRAWINGS

FIG. 1A is an outside perspective view of a scanner 10 from prior art.

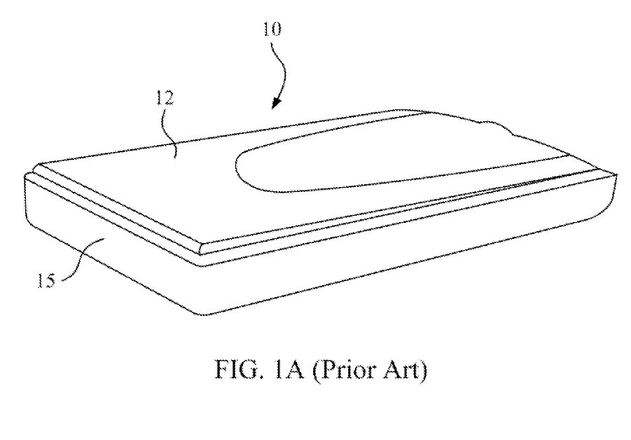

FIG. 1B is a side view of the scanner 10 in FIG. 1A

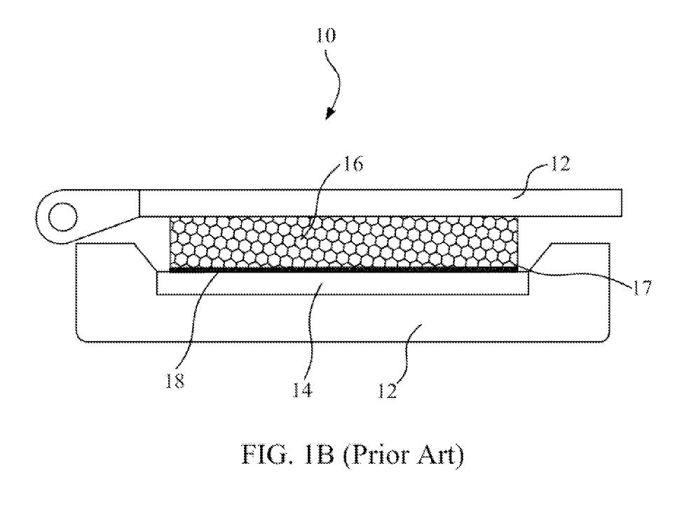

FIG. 1C is another side view of the scanner 10 in FIG. 1A for illustrating the state of the raised opening lid 12 of the scanner.

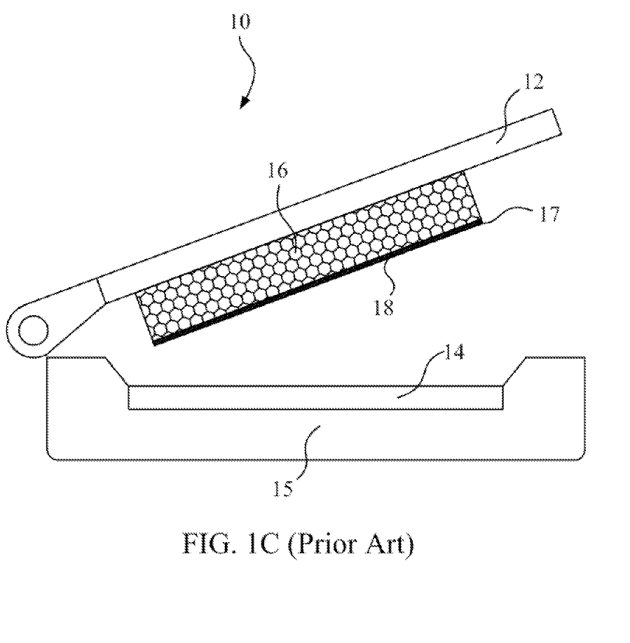

FIG. 2 is an outside view of the office machine 20 according to a preferred embodiment of the invention.

FIG. 3A is a blown-up perspective view of all essential components of the first aligning device 26 shown in FIG. 2.

FIG. 3B is an outside perspective view of the first dam member 32 shown in FIG. 3A.

FIG. 4A is a schematic diagram of the first aligning device 26 shown in FIG. 3A after assembly.

FIG. 4B is another schematic diagram of the first aligning device 26 in FIG. 3A after assembly.

### DETAILED DESCRIPTION OF THE INVENTION

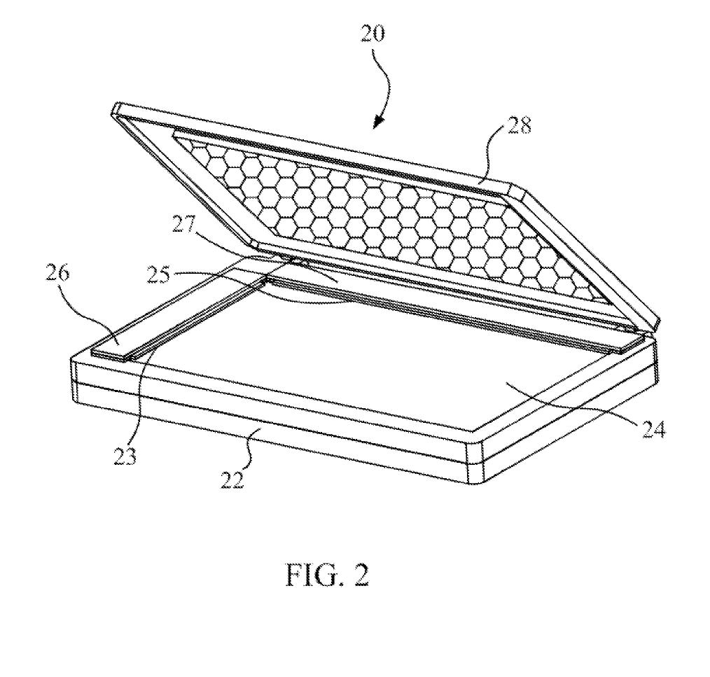

Referring to FIG. 2, FIG. 2 is an outside view of the office machine 20 according to a preferred embodiment of the invention.

Referring to FIG. 2, the office machine 20 includes a housing 22, a transparent platform 24, and an aligning device 26. In practice, the office machine is a scanner, a photocopying machine, or a multi-purpose office machine.

The transparent platform 24, mounted on the housing 22, is used for placing thereon an object to be processed (not shown in figures). The transparent platform 24 thereon has a first starting edge 23, and the object has a thickness.

In an embodiment of the invention, the office machine 20 further includes a lid 28, as shown in FIG. 2. The lid 28 is pivotally connected to the housing 22, and the object is placed between the lid 28 and the platform 24.

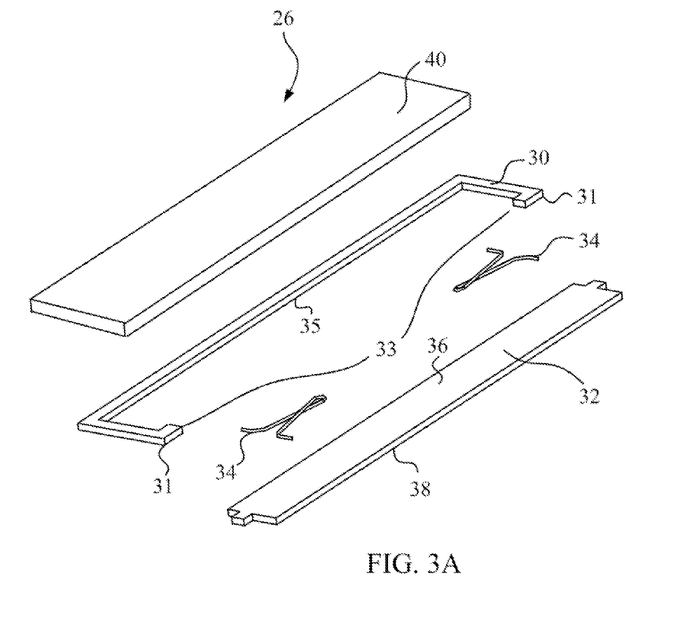

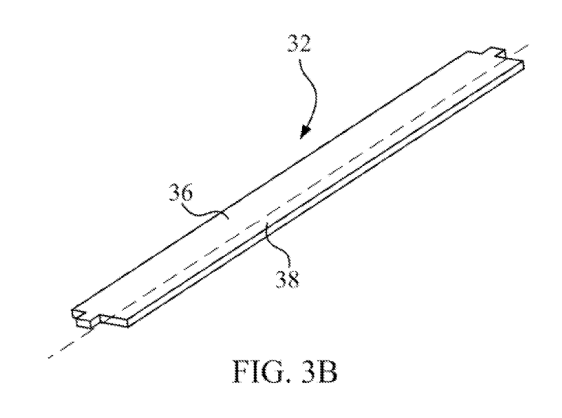

Referring to FIG. 3A, FIG. 3A is a blown-up perspective view of all essential components of the first aligning device 26 shown in FIG. 2. Referring to FIG. 3A, the first aligning device 26 includes a casing 30, a first dam member 32, and a first resilient member 34. The first casing 30 has a first aligning edge 31 and a first opening 33 formed at the first aligning edge 31, and the first casing 30 is attached on the housing 22, such that the first aligning edge 31 of the first casing 30 is aligned with the first starting edge 23.

Referring to FIG. 3B, FIG. 3B is an outside perspective view of the first dam member 32 shown in FIG. 3A. Referring to FIG. 3B, the first dam member 32 has a first main body 36 and a first extension portion 38. The first main body 36 is movably retained inside the first casing 30. The first extension portion 38 protrudes from the first main body 36 through the first opening 33, and a first gap exists between the first extension portion 38 and the platform 24 when the first casing 30 is attached on the housing 22.

The first resilient member 34 is disposed between a first inner wall 35 of the first casing 30 and the first dam member 32 to press against the first main body 36 of the first dam member 32. In an embodiment of the invention, the first resilient member 34 is a torsional spring.

The first aligning device 26 further includes a first top cover 40, mounted on the first casing 30, for fixing the first resilient member 34 and the first dam member 32 between the first top cover 40 and the platform 24.

Furthermore, in one embodiment of the invention, the first casing 30 further includes a plurality of first positioning columns (not shown in figures) for fixing the position of the first dam member 32 in the first casing 30. Users can use the position of the plurality of first position columns to fix the first dam member 32 in a chosen position. This can increase the convenience in usage and can meet the needs of different users or different objects.

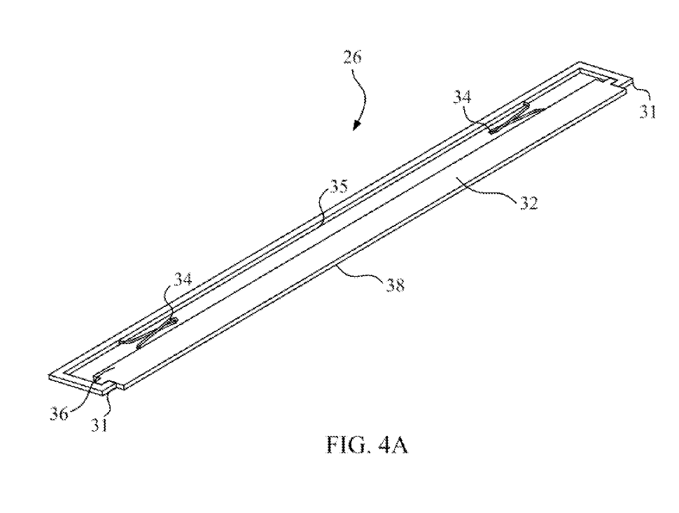

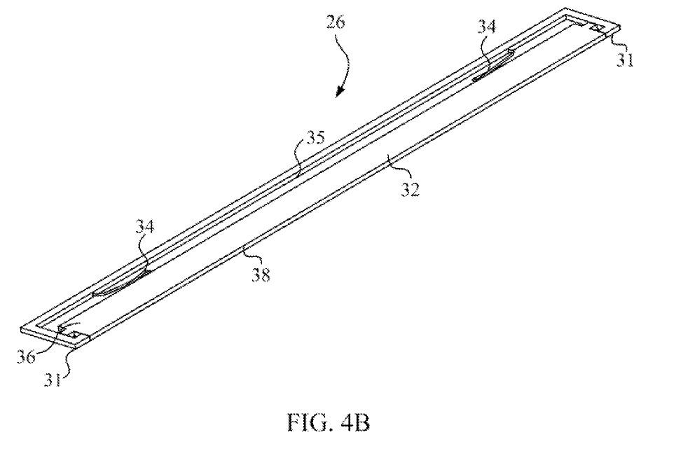

Referring to FIG. 4A, FIG. 4A is a schematic diagram of the first aligning device 26 shown in FIG. 3A after assembly. Referring to FIG. 4A, the first extension portion 38 protrudes from the first main body 36 through the first opening 33.

Moreover, if the thickness of the object is less than the first gap, the object, placed on the platform 24, is inserted into the first gap to make a first edge of the object align with the first aligning edge 31 of the first casing 30. In this case, the state of the first aligning device 26 is shown in FIG. 4A.

Referring to FIG. 4B, FIG. 4B is another schematic diagram of the first aligning device 26 shown in FIG. 3A after assembly. Referring to FIG. 4B, the first dam member 32 of the first aligning device 26 is forced to move inward to the first casing 30. Moreover, if the thickness of the object is greater than the first gap, the object on the platform 24 is placed so that the first edge of the object is pushed against the first extension portion 38, such that the first resilient member 34 is compressed, forcing the first dam member 32 to move inward to the first casing 30, so that a first edge of the object is aligned with the first aligning edge 31 of the first casing 30. In this case, the first aligning device 26 is in a state shown in FIG. 4B.

Referring to FIG. 2, the platform 24 of the office machine 20 has a second starting edge 25 perpendicular to the first starting edge 23. In an embodiment of the invention, the office machine 20 further includes a second aligning device 27, as shown in FIG. 2.

Identical to the first aligning device 26 shown in FIG. 3A, the second aligning device 27 also includes a second casing, a second dam member, and a second resilient member. The second casing has a second aligning edge and a second opening formed at the second aligning edge. The second casing is attached on the housing 22 such that the second aligning edge of the second casing is aligned with the second starting edge.

Identical to the first dam member 32 of the first aligning device 26 shown in FIG. 3B, the second dam member has a second main body and a second extension portion. The second main body is movably retained inside the second casing, and a second extension portion protrudes from the second main body through the second opening. When a second casing is disposed on the housing 22, a second gap exists between the second extension portion and the platform 24.

The second resilient member is disposed between an inner wall of the second casing and the second dam member to press against the second main body of the second dam member. In an embodiment of the invention, the second resilient member is a torsional spring.

Similarly, if the thickness of the object is less than the second gap, the object, placed on the platform 24, is inserted into the second gap to make a second edge of the object align with the second aligning edge of the second casing. If the thickness of the object is greater than the second gap, the object on the platform 24 is placed so that the second edge of the object is pushed against the second extension portion, such that the second resilient member is compressed, forcing the first dam member to move inward to the first casing, such that a second edge of the object aligns with the second aligning edge of the second casing.

Using the arrangement of the two aligning devices, the first edge and the second edge of the object to be processed can respectively align with the first starting edge and the second starting edge of the platform of the office machine. Thus, the object to be processed can be fixed correctly to the starting position of the office machine, avoiding errors in the result due to the deviation of the object during processing, thereby increasing the convenience in using the office machine.

In practice, the structures of the first aligning device and the second aligning device mentioned in the aforementioned embodiments are basically identical, only differing in the position on the platform and in the sizes of the first starting edge and the second starting edge in response to different platforms. In principle, the structures of the aforementioned first aligning device and the second aligning device do not have to be completely identical. For example, to respond to the changes in sizes, it is needed to use different numbers of resilient members or different resilient members.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An office machine, comprising:
a housing;
a transparent platform, mounted on the housing, for placing thereon an object to be processed, the transparent platform thereon having a first starting edge, the object having a thickness; and
a first aligning device, comprising:
a first casing, having a first aligning edge and a first opening formed at the first aligning edge, being attached on the housing such that the first aligning edge of the first casing is aligned with the first starting edge;
a first dam member having a first main body movably retained inside the first casing and a first extension portion protruding from the first main body through the first opening, wherein a first gap exists between the first extension portion and the platform; and
a first resilient member being disposed between an inner wall of the first casing and the first dam member to press against the first main body of the first dam member;
wherein if the thickness of the object is less than the first gap, the object, placed on the platform, is inserted into the first gap to make a first edge of the object align with the first aligning edge of the first casing.

2. The office machine of claim 1, wherein if the thickness of the object is greater than the first gap, the object, placed on the platform, is pushed via the first edge thereof against the first extension portion such that the first resilient member is compressed, force the first dam member to move inward to the first casing, and the first edge of the object is aligned with the first aligning edge of the first casing.

3. The office machine of claim 2, further comprising a lid pivotally connected to the housing, wherein the object is placed between the lid and the platform.

4. The office machine of claim 2, wherein the first casing further comprises a plurality of first positioning columns for fixing the position of the first dam member in the first casing.

5. The office machine of claim 2, wherein the first resilient member is a torsional spring.

6. The office machine of claim 2, wherein the first aligning device further comprises a first top cover, mounted on the first casing, for fixing the first resilient member and the first dam member between the platform and the first top cover.

7. The office machine of claim 2, wherein the platform thereon has a second starting edge perpendicular to the first starting edge, the office machine further comprises:
a second aligning device, comprising:
a second casing, having a second aligning edge and second opening formed at the second aligning edge, being attached on the housing, such that the second aligning edge of the second casing is aligned with the second starting edge;
a second dam member having a second main body movably retained inside the second casing and a second extension portion protruding from the second main body through the second opening, wherein a second gap exists between the second extension portion and the platform;
a second resilient member being disposed between an inner wall of the second casing and the second dam member to press against the second main body of the second dam member;
wherein if the thickness of the object is less than the second gap, the object, placed on the platform, is inserted into the second gap to make a second edge of the object align with the second aligning edge of the second casing.

8. The office machine of claim 7, wherein if the thickness of the object is greater than the second gap, the object, placed on the platform, pushes via the second edge thereof the second extension portion such that the second resilient member is compressed, forcing the second dam member to move inward to the first casing, and the second edge of the object is aligned with the second aligning edge of the second casing.

9. The office machine of claim 8, wherein the second casing further comprises a plurality of second positioning columns for fixing the position of the second dam member in the second casing.

10. The office machine of claim 8, wherein the second resilient members is a torsional spring.

11. The office machine of claim 1, wherein the second aligning device further comprises a second top cover, mounted on the casing, for fixing the second resilient member and the second dam member between the platform and the second top cover.
